(19) United States
(12) Patent Application Publication
(10) Pub. No.: US 2004/0067411 A1
(43) Pub. Date: Apr. 8, 2004

(54) Adding in-device battery charging capability to battery-powered devices

(76) Inventor: Robert John Lisanke, Saratoga, CA (US)

Correspondence Address: Robert Lisanke, PO Box 2187, Saratoga, CA, 95070-0187, US

(21) Appl. No.: 10/675,392

(22) Filed: Sep. 30, 2003

Related U.S. Application Data
(60) Provisional application No. 60/416,301, filed on Oct. 3, 2002.

(51) Int. Cl. H02J 7/00

(52) U.S. Cl. 429/90; 320/107

(57) ABSTRACT

An in-device battery charging system for battery-powered devices is described. The system allows rechargeable batteries to be recharged without removing them from the battery-powered device. The charging system retrofits battery-powered devices intended for use with disposable batteries. In particular, standard sized batteries may be recharged, maintained, and monitored without removing them from the battery-powered device.

### CROSS-REFERENCE TO RELATED APPLICATIONS

This application claims priority from U.S. Provisional Application Serial No. 60/416,301 on Oct. 3, 2002, the disclosure of which is incorporated herein by reference.

### BACKGROUND OF THE INVENTION

The invention relates to recharging, maintaining the charge of and monitoring the state of rechargeable batteries that are used in portable devices. In particular, the invention addresses the problem of providing in-device charging capability for existing battery-powered devices.

Recently, rechargeable batteries have become available in standard sizes (D, C, A, AA, AAA, 9V) for use in battery-powered devices that are designed to use disposable (non-rechargeable) batteries. When these rechargeable batteries become discharged, they must be removed from the battery-powered device and inserted into a battery charger to be recharged. After charging, the batteries must be re-inserted into the battery-powered device.

Some battery-powered devices employ rechargeable batteries that do not require removal of the battery for the purpose of re-charging. These battery-powered devices have exposed contacts for interface with a charger or they employ wireless transfer of energy from a base station charger to the battery. However, in this case, in-device recharging was an intended feature of the design of the battery-powered device.

Simply inserting standard sized rechargeable batteries into devices that have been designed for use with disposable batteries will lack this useful and convenient in-device charging capability.

### BRIEF SUMMARY OF THE INVENTION

The invention described allows batteries to be recharged while inside a battery-powered device that has not been designed for in-device recharging. Typically, this includes battery-powered devices that have been designed to use disposable (non-rechargeable) batteries. In-device recharging is a more convenient way to recharge the batteries of a battery-powered device, since the device need only be placed in close proximity to a charger base station or cradle to charge, maintain charge, or monitor the state of the batteries.

The invention allows the batteries to be more easily maintained at full charge, since a battery-powered device using an embodiment of the invention may be stored or kept close to the charger while not in use. It is also possible to measure the state of charge, current, voltage, temperature, and, in general, the state of the batteries and charging system, again, without removing the batteries from the battery-powered device.

The invention provides a battery charger which comprises a wireless receiver of energy, a charging circuit, and an attachment or connection means to maintain a connection between a battery and the charging circuit. Charging is possible when an embodiment of the invention is placed in proximity to a compatible wireless transmitter of energy. Various embodiments differ slightly from each other structurally, but all provide a means for in-device battery charging.

One preferred embodiment of the invention is inserted into the battery compartment of a battery-powered device and connected to contacts of the battery-powered device

Another embodiment of the invention is a battery charger that is integrated with each battery and is in contact with the battery terminals, forming a unit that is handled and inserted into a battery-powered device the same way as would be a battery without the integrated battery charger.

In another embodiment, an in-device battery charger includes a wireless sender of data and is bi-directionally coupled to a base station that is both a wireless transmitter of energy and a wireless receiver of data, so as to obtain and use data regarding the state of the batteries or charging system.

### BRIEF DESCRIPTION OF DRAWINGS

FIG. 1 illustrates an embodiment of the invention, comprising: a wireless receiver of energy 11, a charging circuit 13, a connection means illustrated in the figure as an externally insulated conductor 14 to a positive terminal connector 15 and an externally insulated conductor 16 to a negative terminal connector 17.

FIG. 2 illustrates another embodiment of the invention, comprising: a battery 10, a wireless receiver of energy 11, a charging circuit 13, a connection means illustrated in the figure as an externally insulated conductor 14 to a positive terminal connector 15 and an externally insulated conductor 16 to a negative terminal connector 17 wherein the connectors are connected to the battery 10.

FIG. 3 illustrates an operation of an embodiment of the invention in a battery-powered device 18 (not part of the invention) that has a battery compartment 19 (not part of the invention) and battery connection terminals 20 (not part of the invention) to the battery-powered device 18. The figure illustrates a connection means comprising 14,15,16,17 to rechargeable batteries 10, which have been inserted into the battery compartment 19 of the battery-powered device 18. A wireless transmitter of energy 12 is shown, consistent with the typical operation of the embodiment of the invention.

### DETAILED DESCRIPTION

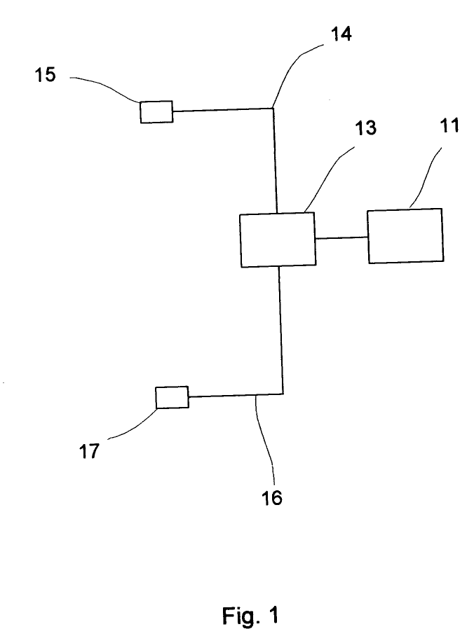

The first and most basic embodiment of the invention is depicted by FIG. 1. A wireless receiver of energy means 11, is connected to a charging circuit means 13, which is connected to a battery via the connection means comprised of a conductor 14 to a positive terminal connector 15 and a conductor 16 to a negative terminal connector 17. When placed in close proximity to a compatible wireless transmitter or sender of energy, a rechargeable battery so connected to embodiment shown in FIG. 1 will receive an electric current capable of recharging the battery. The embodiment of the invention shown in FIG. 1, when used with a battery-powered device containing one or more rechargeable batteries, functions as an in-device battery charger.

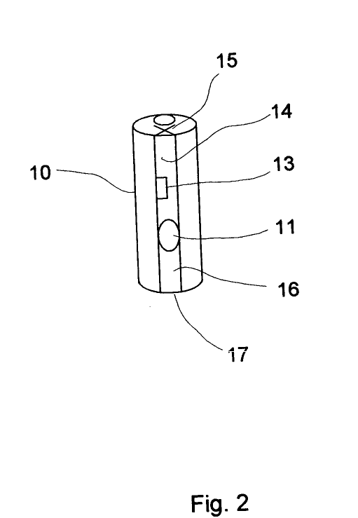

Another embodiment, shown in FIG. 2, constitutes a battery charging device that is integrated with a rechargeable battery 10. Placing the embodiment of FIG. 2 within proximity of a wireless transmitter of energy will cause the battery to recharge or maintain its charge. The primary advantage being in-device charging that might otherwise not be possible with a particular battery-powered device. The battery-with-integrated-charger device embodiment of FIG. 2 has approximately the same physical characteristics as the battery alone, since the battery is relatively much larger than the integrated charging components. This feature allows the battery-with-integrated-charger device embodiment to replace standard sized disposable batteries in portable devices whenever the battery component 10 of the embodiment is a standard sized rechargeable battery component.

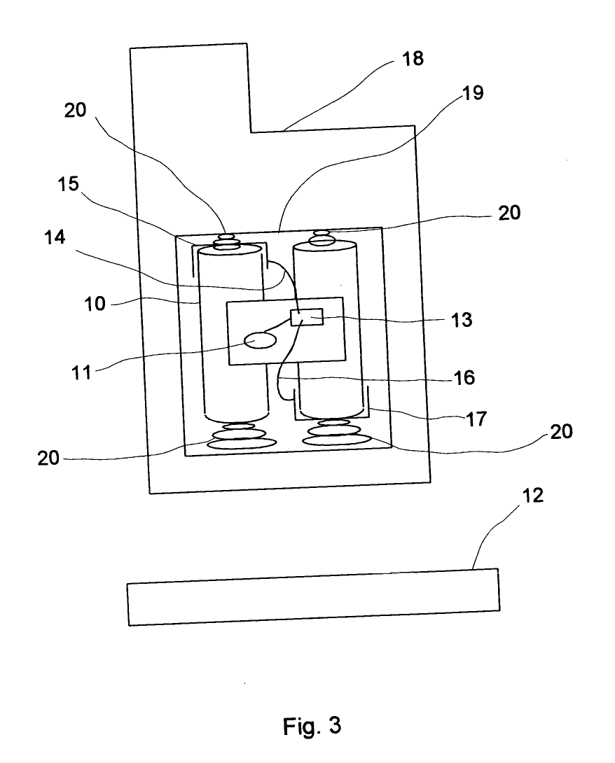

FIG. 3 illustrates a typical operation of an embodiment of the invention. An embodiment of the invention, as a charging device, is inserted into the battery compartment 19 (not part of the invention) of a battery-powered device 18 (not part of the invention). The connector 15 of the connection means of the device has been brought in contact with the positive terminal of the battery-powered device and with the positive terminal of one of the series-connected batteries. The remaining connector 17 has been attached to the negative side. The connectors in this embodiment are cap-style connectors, which, when combined with the force between the battery holder and the battery, mechanically secure the connections. A wireless transmitter of energy 12, positioned near the charging device embodiment of the invention, provides energy for producing a charging current.

What is claimed is:

1. A battery charging device comprising a wireless receiver of energy means, a charging circuit means, and a connector means, whereby said charging circuit means transforms energy from said wireless receiver of energy means to a form suitable for charging a battery or cell that is attached to said charging circuit means by said connector means.

2. The device of claim 1, wherein said connector means comprises two standard snap-type connectors for standard battery size 9V with the first snap connector connected between a battery of type 9V and the second snap connector connected to the battery-powered device.

3. The device of claim 1, wherein said connector means consists of a conductor of a predetermined size and shape and said connector means is held in contact with the terminal of a of a battery powered device by the force of contact between the terminals of the battery and battery-powered device.

4. The device of claim 3, wherein said conductor of said connector means is bumped or convex in an area on one side and dimpled or concave in one area on the other side, whereby said connector means improves the mechanical contact between it and a battery on one side and a terminal of a battery-powered device on the other side.

5. The device of claim 4, wherein said connector means further comprises a cap fitted over the end of the battery connected to said conductor of said connector means such that said conductor is in contact with a battery terminal on one side and a terminal of a battery-powered device on the other side, whereby additional stability is provided for the connector means against movement in a radial direction with respect to the axis of a cylindrically shaped battery.

6. The device of claim 1, further comprising a rechargeable battery connected to said charging means by said connector means, whereby said wireless receiver of energy means, said charging circuit means, and said connection means form a unit or battery with integrated charging capability.

7. The device of claim 6, wherein the device is of a predetermined size whereby it may replace standard sized disposable batteries in portable devices.

8. The device of claim 7, wherein the size and mechanical characteristics of the device are compatible with standard battery size “AA,” whereby the unit may substitute for a battery of size “AA” in a battery-powered device.

9. The device of claim 7, wherein the size and mechanical characteristics of the device are compatible with standard battery size “AAA,” whereby the unit may substitute for a battery of size “AAA” in a battery-powered device.

10. The device of claim 7, wherein the size and mechanical characteristics of the device are compatible with standard battery size “C,” whereby the unit may substitute for a battery of size “C” in a battery-powered device.

11. The device of claim 7, wherein the size and mechanical characteristics of the device are compatible with standard battery size “D,” whereby the unit may substitute for a battery of size “D” in a battery-powered device.

12. The device of claim 7, wherein the size and mechanical characteristics of the device are compatible with standard battery size “9V,” whereby the unit may substitute for a battery of size “9V” in a battery-powered device.

13. The device of claim 7, further comprising a wireless sender of data, whereby the state of a battery as determined by its charge, temperature, terminal voltage, internal resistance, and by its other measurable characteristics is transmitted by wireless means to a wireless receiver of data.

14. A method for performing in-device battery recharging comprising inserting rechargeable batteries into a battery-powered device, connecting a wireless receiver of energy to the battery through a charging circuit, and placing the battery-powered device within close proximity to a wireless transmitter of energy compatible with said wireless receiver of energy whereby a battery-powered device formerly incapable of supporting in-device battery recharging becomes able to support same.
